(19) United States
(12) Patent Application Publication
(10) Pub. No.: US 2008/0005282 A1
(43) Pub. Date: Jan. 3, 2008

(54) METHOD FOR DISPLAYING USER GENERATED CONTENT IN A WEB BROWSER

(76) Inventor: Dewey Gaedcke, Austin, TX (US)

Correspondence Address: JOHNSON & ASSOCIATES, PO BOX 90698, AUSTIN, TX, 78709-0698, US

(21) Appl. No.: 11/556,586

(22) Filed: Nov. 3, 2006

Related U.S. Application Data
(60) Provisional application No. 60/806,529, filed on Jul. 3, 2006.
(60) Provisional application No. 60/827,668, filed on Sep. 29, 2006.

(51) Int. Cl. G06F 15/16

(52) U.S. Cl. 709/219

(57) ABSTRACT

A method and apparatus is provided for use with a web browser for managing and automating the use of social networks and other web sites. For example, users can associate user generated content with third party web pages and to customize the visibility of this content based on multiple modes of authentication. Users may also manage personal profiles and contact lists over multiple social networks. Users can even monetize their popularity by hosting advertisements and being paid based on their respective level of viewer ship. Various other features are also available for use by users that will enhance their social networking experience and provide the users with increased control of their personal profiles.

### CROSS REFERENCE TO RELATED APPLICATIONS

This application claims priority under 35 U.S.C. § 119 to the following co-pending, commonly owned United States provisional patent applications: Ser. No. 60/806,529, filed on Jul. 3, 2006, attorney docket number MIN.P0001, entitled “SYSTEM AND METHOD FOR MANAGING SOCIAL NETWORKS”, (pending); Ser. No. 60/827,668, filed on Sep. 29, 2006, attorney docket number MIN.P0002, entitled “SYSTEM AND METHOD FOR DISPLAYING USER GENERATED CONTENT IN A WEB BROWSER”, (pending); both of which are incorporated by reference herein.

### FIELD OF THE INVENTION

This invention relates to displaying content on a web browser. In particular, this invention is drawn to systems and methods for managing and displaying additive user generated content relating to social networks and other web sites.

### BACKGROUND OF THE INVENTION

Generally, a social network is a social structure consisting of individuals or organizations. Users of social networks are connected together through various social familiarities such as friends, family, acquaintances, users having similar interests, etc. In an Internet environment, social networking typically refers to web sites to help users connect to friends, business acquaintances, etc.

A typical social network in an Internet environment may offer users places to store and post profiles, blogs, groups, photos, videos, etc. A typical user profile in a social network may include sections about interests of the user such as music, books, movies, marital status, physical appearance, etc. Some social networking sites also allow users to organize links to their friends' from that particular social network as a “friends list”. Examples of typical Internet based social networks include MySpace, Facebook, Match, Classmates, Friendster, Linkedln, orkut, Youtube, Xanga, etc.

Social networks and other web sites have various problems. Some users may have accounts at multiple websites. For a user that belongs to multiple social networks, the user may find it cumbersome to manage separate profiles or repurpose content among the various social networks to which they belong. If the user wishes to organize a friend list, post personal content, or send and receive email, they must do so separately for each social network.

One problem with social networks relates to security. Social networks have become very popular with children and teenagers. While some social networks allow profiles to be visible only to “friends”, information on friends pubic pages such as addresses, phone numbers, last names, pictures, etc. could place a person in danger. Unfortunately, typical social networking web sites do not allow users to adequately control and secure specific sections of profiles and personal content. Those sites that do offer partial visibility control, don't allow this control to extend to every site upon which the content is displayed.

### SUMMARY OF THE INVENTION

A method of the invention is provided for displaying content at an internet client including: providing a database containing information on a plurality of profile owners, wherein for each of the plurality of profile owners, the database stores content generated by the respective profile owner, and wherein the content is intended to be displayable in conjunction with one or more web pages; receiving a request from a first user of an internet client to view a first web page containing information relating to a profile of a first profile owner; determining whether at least a portion of the requested first web page corresponds to content stored in the database; and displaying at the internet client of the first user the first web page with content added from the database, wherein the content added from the database is content generated by the first profile owner.

Another embodiment of the invention provides a method of displaying content on an internet client including: receiving a request from a first user of an internet client to view a first web page containing information relating to content generated by a second user; receiving content at the internet client from a first web server, the content corresponding to the first web page; receiving content at the internet client from an application server, the content from the application server relating to content generated by the second user; and displaying on an internet browser at the internet client a customized web page containing content from the first web server and the content from the application server.

Other features and advantages of the present invention will be apparent from the accompanying drawings and from the detailed description that follows below.

### BRIEF DESCRIPTION OF THE DRAWINGS

The present invention is illustrated by way of example and is not limited by the figures of the accompanying drawings, in which like references indicate similar elements and in which:

FIGS. 1-4 are a block diagrams of examples of the present invention implemented in an internet environment.

FIGS. 5 and 6 are flowcharts illustrating examples of processes for displaying additional third party content in conjunction with a second party web page.

FIG. 7 is a flowchart illustrating one example of a process for determining whether profile owner generated content is available for a particular web site.

FIG. 8 is a flowchart illustrating one example of a process for determining whether additional content is available for a particular web page.

FIG. 9 is a flowchart illustrating one example of a process for determining whether owner generated content is available for a particular web site.

FIG. 10 illustrates a state diagram illustrating one example of an implementation of the present invention.

FIG. 11 is a diagram of a web browser, as it would be viewed by a user of a network client.

FIG. 12 is a diagram of a Web browser, with a toolbar (and underlying web page) placed in edit mode.

FIG. 13 is a diagram of a Web browser, illustrating added content and possible anchor points.

FIG. 14 is a diagram of a Web browser, illustrating a view as the added content is dragged toward an anchor point.

FIG. 15 is a diagram of a Web browser, illustrating a view of added content anchored in place.

FIG. 16 is a diagram of a Web browser, illustrating the addition of more content.

FIG. 17 is a diagram of a Web browser, illustrating a view of a web page with content added pursuant to the present invention.

FIG. 18 is a diagram of a Web browser, illustrating a toolbar having a multi-site friends list displayed.

FIG. 19 is a diagram of a Browser toolbar embodying the present invention.

### DETAILED DESCRIPTION

Generally, the present invention relates to techniques for managing and automating the use of social networks and other web sites. For example, in the context of social networks, the invention provides tools that put users in control of information in their social networks by allowing users to place “post-it note” style pagelets onto third party web sites and to customize the substance and visibility privileges of this content. The invention allows users to easily communicate and share private content with other people, in ways chosen by the users, and across multiple sites simultaneously. The invention also allows users to manage personal profiles, related content and disparate friends over multiple social networks. The present invention enables various user features that will enhance their social networking experience and allow the user increased control of their personal profiles.

In order to provide a context for understanding this description, the following description illustrates examples of environments in which the present invention may be used. Of course, the invention may also be used in other types of environments. In the example of a web environment, the present invention provides a tool, used in conjunction with a Web browser, to help a user manage information, such as profiles on social networking web sites, as well as enabling various features that enhance the user's web experience. Examples of how the present invention may be implemented include, but are not limited to, and Internet browser toolbar, a browser extension, a browser plug-in, an executable program that communicates with the browser, etc.

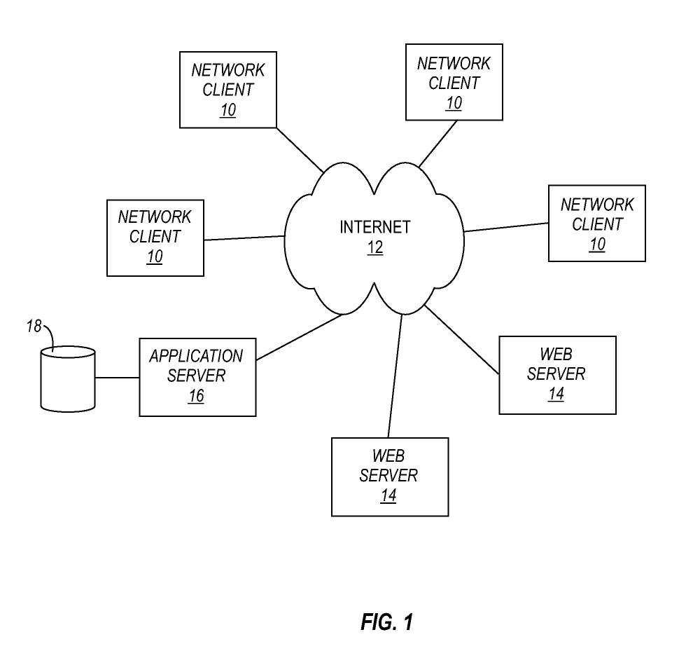

FIGS. 1-4 are block diagrams of examples of the present invention implemented in a web environment. Note however, that the invention can also be implemented in other environments as well (e.g., private networks, etc.). FIG. 1 is a block diagram showing a plurality of network clients 10 coupled to a network (in this example, internet 12). The network clients 10 may be comprised of any desired type of client, such as a computer, phone, PDA, network appliance, etc. A typical network client may include a processor(s), a storage device(s) (memory, hard drive, etc.), user interface device(s) (e.g., keyboard, keypad, mouse, etc.) and a display. A plurality of web servers 14 are also coupled to the internet 12. The web servers 14 each host one or more web sites, which may be accessed and viewed by internet browsers installed on the internet clients 10. An application server 16 is also coupled to the internet 12. The application server 16 has access to a database 18 (described below).

When a user of one of the network clients 10 requests to view a web page hosted by one of the web servers 14, the web browser of the network client 10 will send a request to the appropriate web server 14, which will send web page html content back to the network client 10, where the content will be rendered and displayed for the user. By accessing the application server 16, the invention running on the network client 10 is able to provide the user with various additional functions (described in detail below). For example, the database 18 may store additional content that has been associated with the web page (or portions thereof) retrieved from one of the web servers 14. The invention running on the network client may also use the application server to help facilitate the centralized management of multiple web sites (e.g., social networking web sites), the management of multi-site friends lists, the management of content and profiles across multiple web sites, etc. Descriptions of various examples are described in detail below.

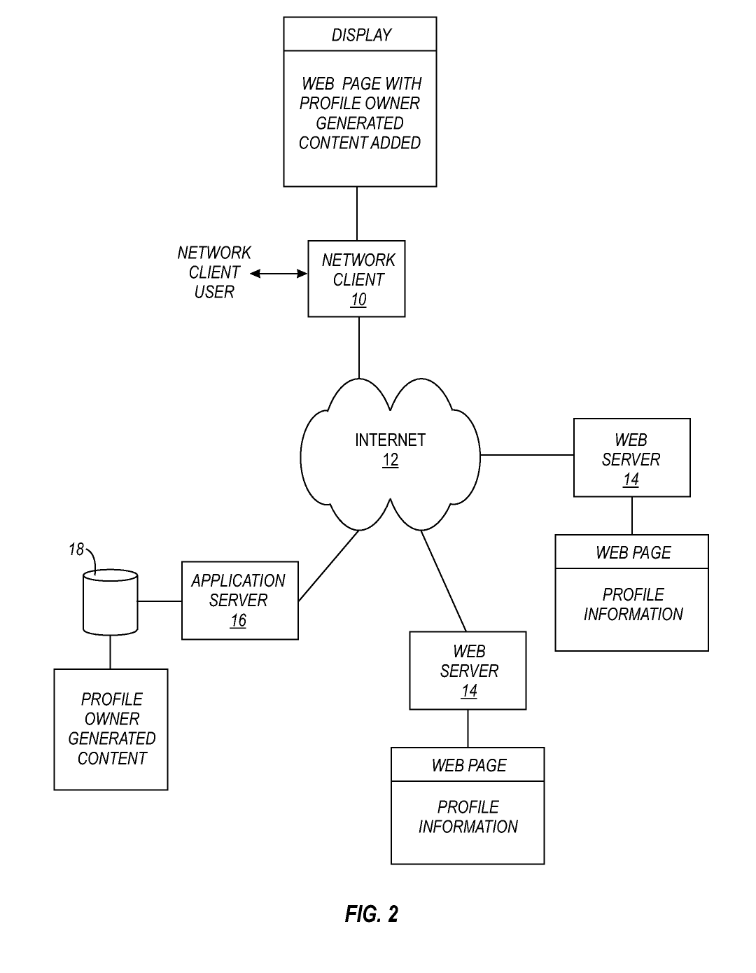

FIG. 2 is a block diagram of an example of the present invention implemented in a web environment for use with social networks. Like FIG. 1, FIG. 2 shows a plurality of web servers 14 coupled to the Internet 12. In this example, the web servers 14 host social networking web sites. FIG. 2 also illustrates that the web servers 14 host web pages that contain profile information relating to users of the social networks. FIG. 2 also shows a network client 10 coupled to the Internet 12. Note that, for clarity, only one network client and is shown in FIG. 2, although any desired number of network clients may be used. An application server 16 and database 18 are also coupled to the Internet 12.

In the example illustrated in FIG. 2, software installed on the network client 10, along with the application server 16, provide the network client user with enhanced features. For example, when the user views a web page containing profile information, the network client 10 will display the web page, along with profile owner generated content, that is stored in the database 18. If no such content exists, the network client 10 will simply display the web page provided by the corresponding web server 14. The operation of the invention in this manner as described in detail below. Note that, with the invention, the application server 16 and database 18 can provide owner generated content for multiple web pages over multiple social networks. The term “profile owner” is intended to refer to a person or user that has at least partial control over the content that appears on the native web page.

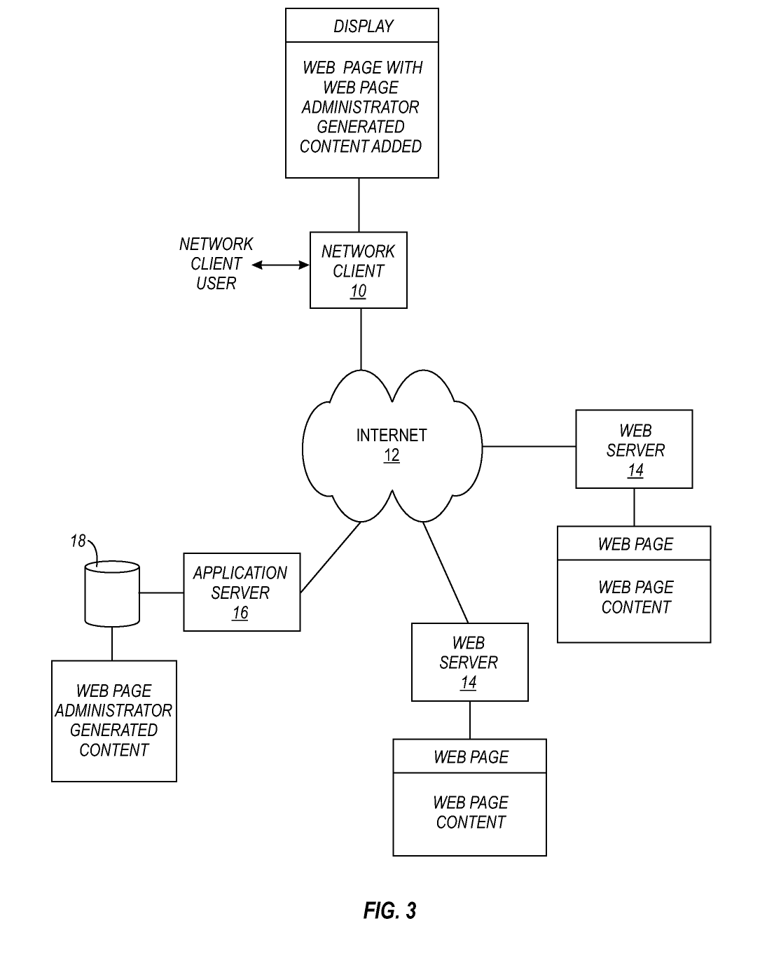

FIG. 3 is a block diagram of another example of the present invention. FIG. 3 is similar to FIG. 2, but relates to any type of web page where a web page administrator (or other user) wishes to generate additional content using the invention. FIG. 3 also shows a plurality of web servers 14 coupled to the Internet 12. In this example, the web servers 14 host pages, containing web page content. A network client 10, application server 16, and database 18 are also coupled to the Internet 12. In the example, when the user of the network client 10 views a web page hosted by one of the web servers 14, the network client 10 will display the web page, along with any generated content stored in the database 18 that is intended to be displayed with the requested page. If no such content exists, the network client 10 will simply display the web page provided by the corresponding web server 14.

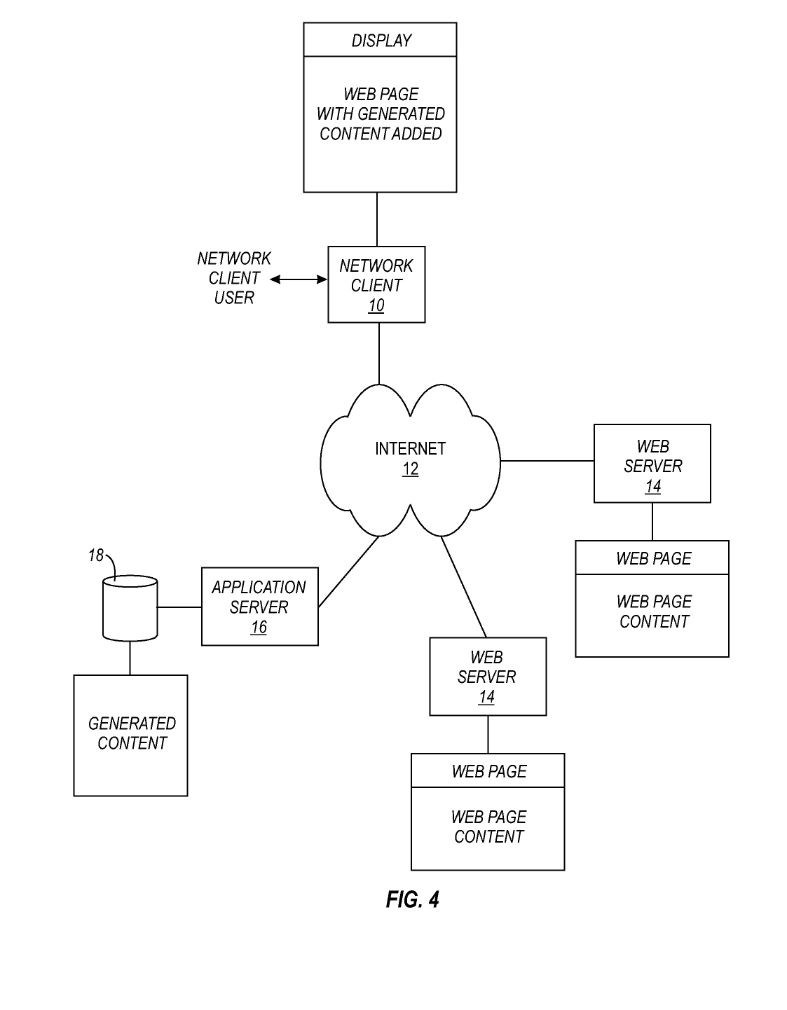

FIG. 4 is a block diagram of another example of the present invention. FIG. 4 is similar to FIGS. 2 and 3, but can relate to any type of web page where someone desires to add content to the web page. Like FIGS. 2 and 3, FIG. 4 shows a network client 10, web server 14, application server 16, and database 18 coupled to a network. In this example, when the user of the network client 10 views a web page hosted by one of the web servers 14, the network client 10 will display the web page, along with any generated content stored in database that is intended to be displayed with the requested page. If no such content exists, and the network client 10 will simply display the web page provided by the corresponding web server 14.

As mentioned above, another feature of the present invention relates to control of content on a social networking (or other) web site. In a typical social networking web site, when a profile owner publishes content to their profile, the content is there for everyone to see, even if the user would prefer to keep some portions private. The present invention provides a way for a user to add content (aka “personal content” or “private content”) to their profile, while maintaining control of the content visibility at a granular level. In one example, content generated by the profile owner is injected into the profile page of any desired social networking web site by the web browser and associated toolbar of the user viewing the profile page. This content can be viewed by other users, without altering the original content of the profile page hosted by the social networking web site. Other users of the present invention are able to view the owner generated content (assuming they have permission, described below) while they are viewing the original profile web page. For example, a first profile owner can add private content to his or her profile page via the invention (described below). Someone not using the appropriate software would not even know that the owner generated content existed. However, someone using the appropriate software, if authenticated, would know and see the added content. The network client can be configured to display the content in any desired manner. For example, the owner generated content could be displayed automatically when a user visits the corresponding web page, or the user may just be notified that owner generated content existed, allowing the user to choose whether or not to view the additional content.

One feature of the present invention relating to the use of owner generated content relates to controlled access of the content. In one example, a profile owner may not care if everyone can view the owner generated content. In this example, no permission would be required to view the owner generated content, and anyone with the appropriate software could view it. In another example, a profile owner may only desire certain people to view the owner generated content. The invention allows the owner generated content to be viewed by only people having proper permissions. Access to owner generated content can be controlled using various techniques such as: passwords, specific user permissions, group permissions, age verifications, time restrictions (e.g., the content may only be visible during certain times), personal attributes, digital certificates, etc., as well as any combination of these and other techniques. In some social networks, profile owners maintain a list of friends or contacts. In one example, the profile owner may configure the owner generated content to only be available/visible to people (or subsets of people) in the owner's list of contacts. Note that an owner may have multiple contact lists. For example, the owner may have friends list from various social networking web sites, as well as one or more multi-site friends lists enabled by the present invention. The user permission status may be based on any list, or combinations thereof. In another example, authorization to access owner generated content can be based on any number of a user's many profile attributes. For example, a user may have his/her own profile page containing various profile attributes. A profile owner can specify that certain owner generated content be accessible to users whose profile attributes meet one or more requirements (e.g., fall within a specified age group, be from a specified city or area, have specified interests, etc.). Examples of profile attributes may include account information, attributes from one or more registered profiles, tags, comments other people have made about a user, application usage history, etc. Also note that different sets of attributes (i.e., filters) can be applied individually to different content blocks. For example, a profile owner can configure one content block to be visible to people in a particular zip code, and another content block to people that have a registered profile with a particular social network. Numerous other examples are also possible.

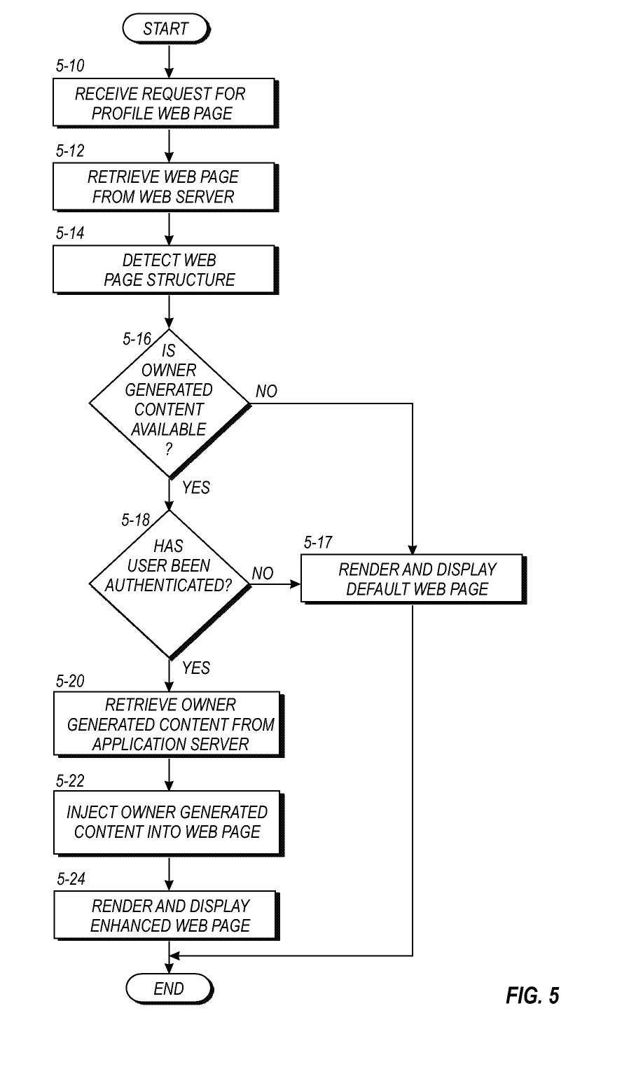

FIG. 5 is a flowchart illustrating one example of a process for displaying profile owner generated content along with a profile web page. However, the invention can be implemented using various other processes, as one skilled in the art would understand. The process illustrated in FIG. 5 begins at step 5-10, where a request for a profile web page is received. Referring back to FIG. 2, the request may originate from a network client, resulting from a user requesting to view a profile web page hosted by a Web server. At step 5-12, the requested web page is retrieved from the web server. These steps may be accomplished in any desired manner, such as by using HTTP protocol. At step 5-14, the retrieved structure of the web page is rendered and partially displayed on a web browser installed on the network client. Alternatively, the display of the web page could wait until all of web page content and owner generated content is received.

The next part of the process illustrated in FIG. 5 relates to determining whether owner generated content exists, whether the user of the network client is authorized to view the owner generated content, and displaying any owner generated content. As mentioned above, the profile owner of the web page displayed at the network client may have generated content corresponding to the retrieved web page (or portions thereof), and stored that content in the database of the application server. At step 5-16, the process asks whether any owner generated content is available. This can be determined in any desired manner, although specific examples are described below. If it is determined that no owner generated content is available, the web browser renders and displays the default web page normally (step 5-17), and the process ends. If owner generated content is available, the process proceeds to step 5-18. At step 5-18, the process asks whether the user has been authenticated to view the owner generated content. In other words, the process determines whether the profile owner has given (specifically or through attribute matching, for example) the user permission to view the owner generated content. If the user has not been authenticated, the process proceeds to step 5-17, where the web browser renders and displays the default web page. If the user is authenticated, the process proceeds to step 5-20, where the network client retrieves the owner generated content from the application server. Next, at step 5-22, the owner generated content from the application server is injected into the web page. At step 5-24, the web browser renders and displays an enhanced web page (e.g., the default web page from the web server, plus the injected content). The owner generated content can be displayed in any desired manner. Examples are provided in detail below.

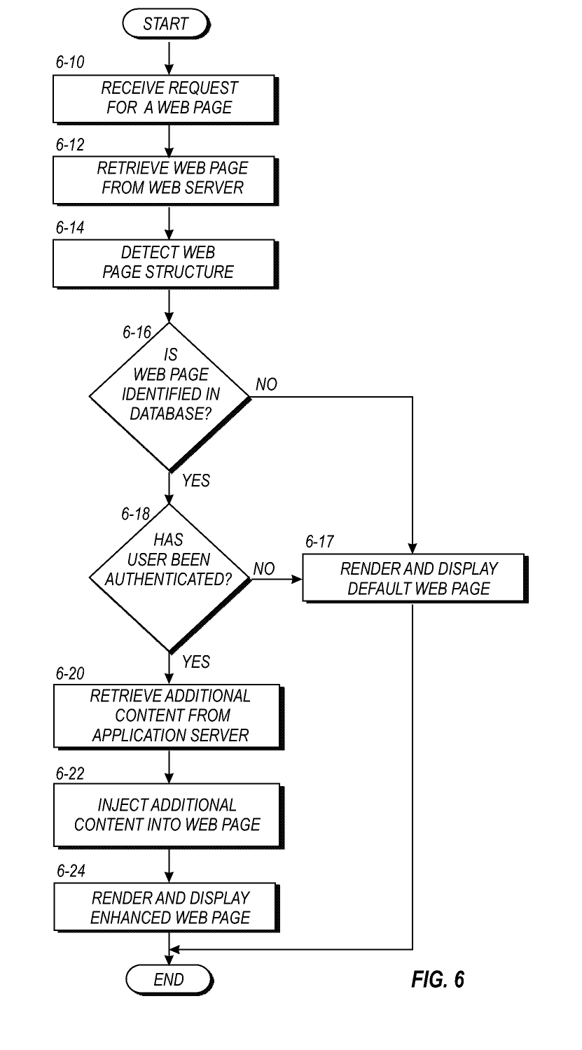

FIG. 6 is a flowchart illustrating one example of a process for displaying additional content along with a web page. The process illustrated in FIG. 6 begins at step 6-10, where a request for a web page is received. At step 6-12, the requested web page is retrieved from the web server. At step 6-14, the retrieved structure of the web page is rendered and partially displayed on a web browser installed on the network client.

The next part of the process illustrated in FIG. 6 relates to determining whether additional content corresponding to the requested web page exists, whether the user of the network client is authorized to view the content, and displaying the additional content. As mentioned above, someone may have generated content corresponding to the retrieved web page (or subset thereof) and stored that content in the database of the application server. At step 6-16, the process asks whether the retrieved web page (or profile owner attribute(s) generally) is identified in the database (i.e., whether content exists in the application server database that corresponds to the retrieved web page). This can be determined in any desired manner, although specific examples are described below. If it is determined that the retrieved web page is not identified in the database (i.e., no content corresponding to the retrieved web page exists), the web browser renders and displays the default web page normally (step 6-17), and the process ends. If it is determined that the retrieved web page is identified in the database, the process proceeds to step 6-18. At step 6-18, the process asks whether the user has been authenticated to view the additional content stored in the application server database. If the user has not been authenticated, the process proceeds to step 6-17, where the web browser renders and displays the default web page. If the user is authenticated, the process proceeds to step 6-20, where the network client retrieves the additional content from the application server. Next, at step 6-22, the additional content from the application server is injected into the web page. At step 6-24, the web browser renders and displays an enhanced web page (e.g., the default web page from the web server, plus the injected content). The additional content can be displayed in any desired manner. Examples are provided in detail below.

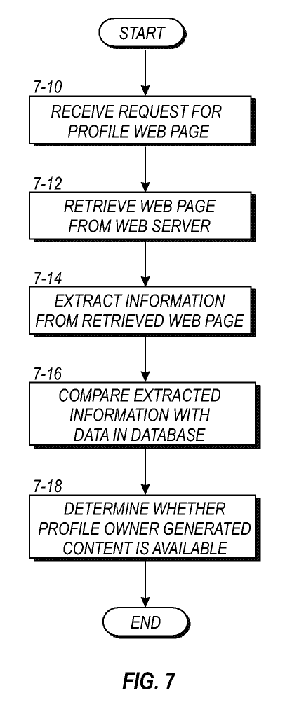

As mentioned above, in order to retrieve and display the content from the application server, the application server needs to determine whether the web page (or subset thereof) retrieved by the network client corresponds to any of the content stored in the application server database. This determination can be achieved in any desired way. FIG. 7 is a flowchart of one example of a process for determining whether profile owner generated content is available for any particular web site. Note that while the example of FIG. 7 refers to owner generated content, and a profile web page, the invention is not limited to profile web pages and owner generated content.

The process illustrated in FIG. 7 begins at step 7-10, where a request for a profile web page is received. At step 7-12, the requested web page is retrieved from the web server. Note that steps 7-10 and 7-12 are similar to steps 5-10 and 5-12 in FIG. 5. After the requested web pages retrieved, software on the application client extracts information from the retrieved web page. The information extracted may include any desired information that can be used to cross-reference the retrieved web page with the application server database. Detailed examples are described below. Next, at step 7-16, the extracted information is compared with data stored in the application server database. At step 7-18, the process determines whether profile owner generated content is available that corresponds to the retrieved web page (or subset thereof). Once the determination has been made, this content can be delivered, as described above.

In one example, steps 7-16 and 7-18 are performed by the application server based on the contents of the application server database and the extracted information received from the network client. The communication between the application server and the network client can be implemented in any desired manner. In one example, a protocol such as a SOAP or remote procedure call (RPC) can be used over HTTP. In this example, software in the network client generates a message for the application server. The RPC message instructs the application server to execute scripts, and includes at least some of the extracted information. The application server executes scripts that determine whether the web page (or content therefrom) retrieved by the network client corresponds to user data identified in the application server database. This determination by the application server is made based on a comparison of the extracted information received from the network client and information stored in the application server database. More specific examples of this determination are described below.

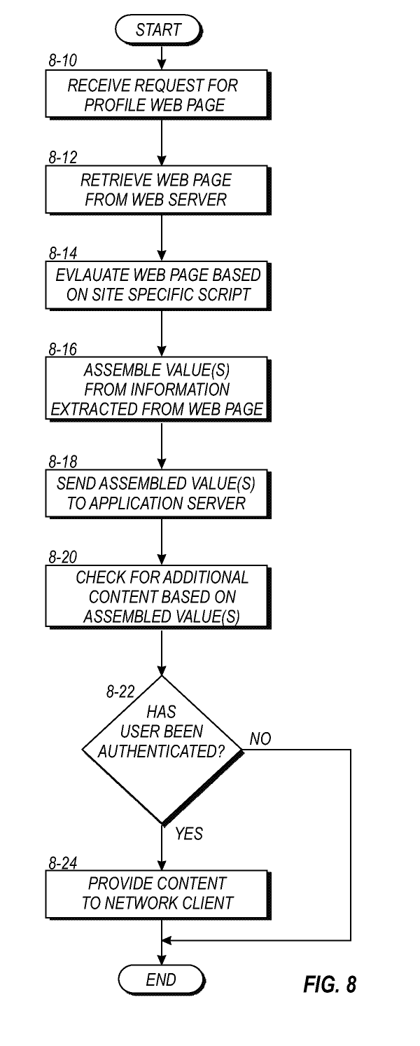

FIG. 8 is a flowchart of another example of a process for determining whether additional content is available for the web page retrieved by the network client. The process begins at step 8-10, where a request for a profile web page is received from the network client. At step 8-12, the requested web page is retrieved from the Web server. Next, at step 8-14, software on the network client evaluates the retrieved web page based on site specific scripts. Since different web sites are arranged and configured in different ways, different web sites may be evaluated in different ways. For example, for all web pages originating from a first social network web site, a first script may be used, which is configured based on the way that web pages from that web site are constructed. For another social network, different scripts may be used, which are configured based on the way that web pages from this social network web site are constructed. Similarly, other scripts may be used for other web pages. If desired, a script can be designed to evaluate web pages where the organization and arrangement of the web page is unknown and dynamically add support for such features as “auto-login” by users of the present invention.

After the web site has been evaluated, the process proceeds to step 8-16 where values are assembled from information extracted from the web page. The assembled values may vary depending on the content of the web page, the identity of the originating web site, and other factors. Although the assembled values and extracted information can include any desired type of information, examples may include, but are not limited to, usernames, user IDs (e.g., a profile owner identifier), URLs, profile attributes, other content relating to the web page, etc. At step 8-18, the assembled values are sent to the application server. In one example, the assembled values are included in an RPC message that is sent to the application server.

At step 8-20, the application server determines whether there is content stored in the application server database that corresponds to the web page retrieved by the network client. This determination is based on an analysis of the assembled values and information stored in the application server database. In one example, where a site-specific script specifies a comparison of an extracted user ID, the application server would compare the extracted user ID with user IDs stored in the application server database. If no match is found, the application server has determined that no content exists in the database relating to the web page retrieved by the network client. If a match is found, the application server delivers the content stored in the application server database to the network client. In other examples, a site-specific script may specify a comparison of other value(s) with value(s) stored in the database. In another example, where a site-specific script specifies a comparison of a web page URL, the application server will compare the extracted URL with URLs stored in the application server database. As one skilled in the art would understand, the determination of the existence of content corresponding to a specific web page can be achieved in many desired ways.

If, at step 8-20, content is identified that corresponds to the web page retrieved by the network client, the process proceeds to step 8-22. At step 8-22, the process asks whether the user of the network client is authorized to view the content stored in the application server database. If the user is not authorized, the process ends. If the user is authorized, the process proceeds to step 8-24, where the authorized portions of the content is provided to the network client. When the network client receives the content from the application server, the content can be injected into the page and displayed by the browser, as described above.

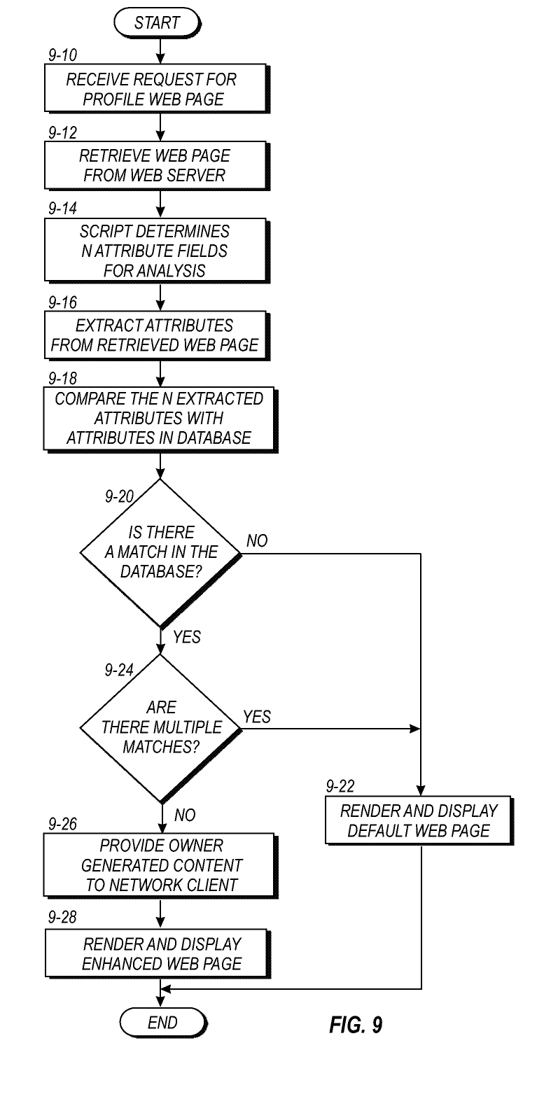

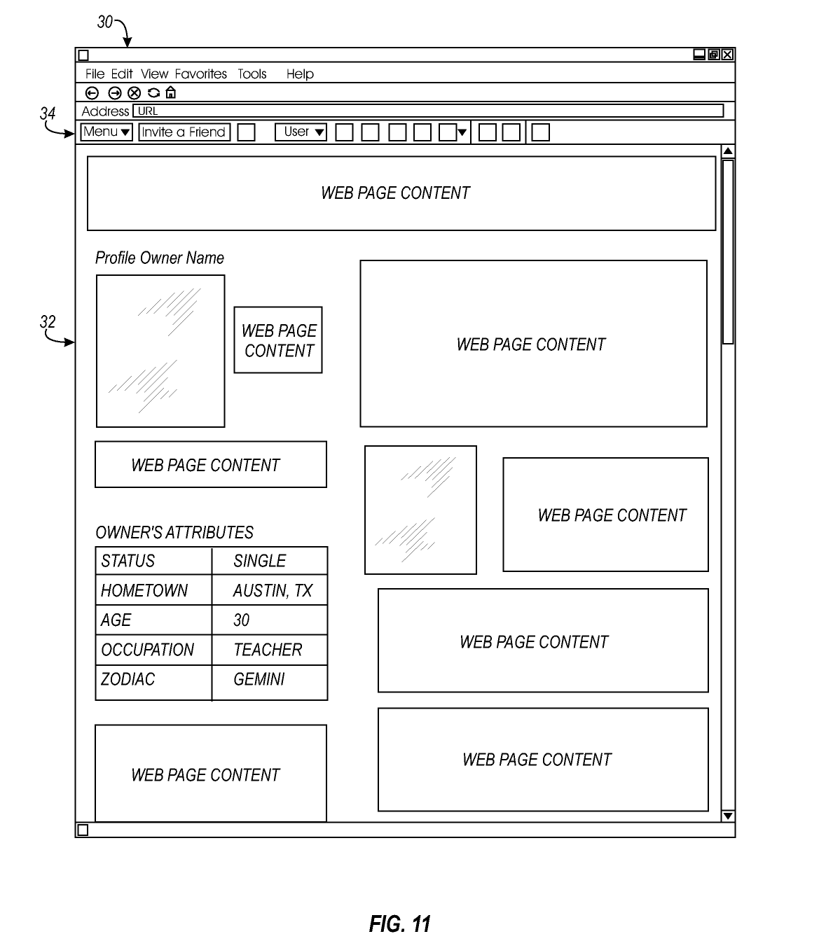

FIG. 9 is a flowchart illustrating another example of a process for determining whether owner generated content is available for a profile web page retrieved by the network client. In the example illustrated in FIG. 9, the site-specific script used by the network client to evaluate the web page relates to the use of one or more profile attributes which can be found on a profile page. The process illustrated in FIG. 9 begins at step 9-10, where a request for a profile web page is received from the network client. At step 9-12, the requested web page is retrieved from the web server. Next, at step 9-14, the site-specific script selects one or more profile attribute fields from the retrieved web page for analysis. At step 9-16, data corresponding to the selected profile attribute fields is extracted from the retrieved web page. In FIG. 9, the one or more attribute fields are designated as “N” attribute fields, where N is the number of attribute fields. The specific profile attribute fields selected for analysis are dictated based on the site-specific script corresponding to the web page retrieved. As an example, a site-specific script may specify the selection of certain profile attribute fields, such as “hometown”, “occupation”, and “zodiac”. On a profile web page, a profile owner typically enters data into a set of attribute fields. This data entered into the set of fields is the data that will be extracted. FIG. 11 (described below) shows an example of a profile web page as viewed by a web browser, and illustrates various examples of profile attribute fields.

At step 9-18, the extracted attributes are compared with attributes stored in the application server database. At step 9-20, the process asks whether a match was found in the application server database. If it is determined that no match was found in the application server database, the web browser renders and displays the default web page normally (step 9-22), and the process ends. If, however, a match is found, the process asks, at step 9-24, whether multiple matches were found. Since it is possible that two or more profile owners may have identical information entered into the selected attribute fields, the application server may not know which entry in the application server database corresponds to the web page retrieved by the network client. In the example shown in FIG. 9, the process proceeds to step 9-22 if multiple matches are found. In other examples, the application server may respond to multiple matches in other ways, such as comparing more attributes, proceeding to secondary matching techniques, etc. If a single match is found in the application server database, the process proceeds to step 9-26, where the corresponding owner generated content is provided to the network client. At step 9-28, the web browser renders and displays an enhanced web page (e.g., the default web page from the web server, plus the injected content).

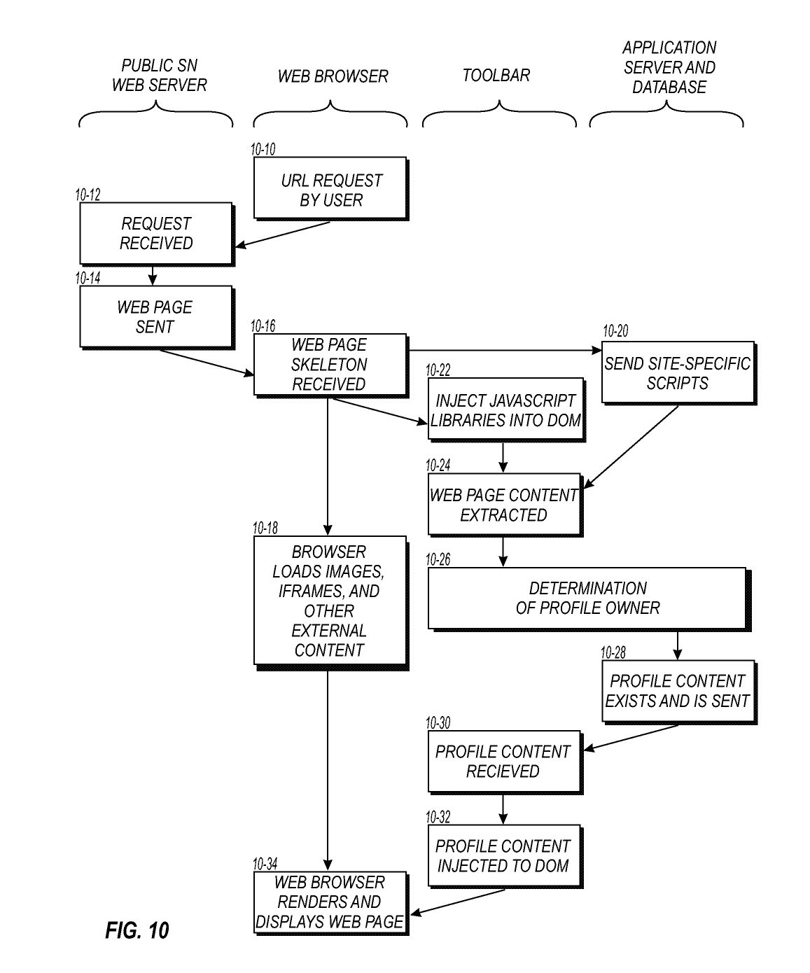

To further illustrate the operation of the present invention, FIG. 10 illustrates a state diagram relating to one example of an implementation of the present invention. The state diagram shown in FIG. 10 is intended to show various operations and the handler that executes each operation. FIG. 10 is described in the context of the invention implemented using a web browser toolbar (or other browser helper object) in a social network environment. Note that FIG. 10 is merely one example of an implementation of the present invention, and that many other implementations are possible, as one skilled in the art will understand. In FIG. 10, the operations illustrated are executed by the handler located directly above the operation, as illustrated in FIG. 10.

FIG. 10 shows four event handlers including a public social network web server, a web browser, a toolbar, and an application server and database. In this example, the web server is a typical social network web server that hosts a web site containing profile content maintained by multiple profile owners. The web browser is a browser installed on a network client, such as a computer, phone, etc. The toolbar is a web browser toolbar, but could also be implemented in numerous other ways, such as extensions, plug-ins, or other software, etc. In this example the application server is implemented using a web services protocol, such as Simple Object Access Protocol (SOAP), Hessian, or remote procedure call (RPC). The database stores owner generated content, which corresponds to a web pages (or portions thereof) hosted by the web server.

FIG. 10 assumes that the web browser installed on a network client has already been launched. When an end user requests a URL hosted by the web server (operation 10-10), the web browser sends a request to the web server. After the web server receives the request (operation 10-12), the web page corresponding to the URL is sent back to the web browser (operation 10-14). The web page skeleton (i.e., HTML relating to the structure & content of the requested web page) will be sent by the web server.

After the web browser receives the web page skeleton (operation 10-16), the web browser will start loading images, iframes, and other external content (operation 10-18). In parallel (or before or after depending upon the page) with operation 10-18, the application server will send (if not already cached) site-specific scripts to the toolbar (operation 10-20). The toolbar will inject various javascript libraries into the DOM (operation 10-22). Note that, in one example, the toolbar may include portions running in various programming methodologies, such as javascript, ActiveX, AJAX and C++, for example. After receiving the site-specific scripts, the toolbar extracts content from the received web page (operation 10-24). The toolbar and application server will determine, from the extracted information, whether the requested web page corresponds to a profile owner identified in the database (operation 10-26). If the toolbar and application server determine that the requested web page corresponds to a profile owner identified in the database, the authenticated portions of profile owner generated content stored in the database is sent to the toolbar (operation 10-28). Once the profile content is retrieved by the toolbar (operation 10-30), the profile content is injected into the retrieved web page. In one example, this is accomplished by injecting the profile content into the web browser document object model (DOM) memory (operation 10-32). Finally, the web browser renders and displays the requested web page, including content received from the web site or server, and content received from the application server (operation 10-34). Note that, in some examples, the web browser may start displaying the requested web page before receiving any content from the toolbar and application server.

The following is a description illustrating how the present invention can enable a profile owner to add content to the profile owner's hosted web page. Generally, the invention enables someone to add content to a web page, without altering the original web page as hosted by the website. Access to the edited content can be controlled so as to give desired people access to the extra hidden content. The invention provides the content owner with the greater control over the visibility, substance and portability of their online content and media assets.

FIGS. 11-17 are diagrams illustrating how a profile owner can add content to a web page, as well as illustrating how the content will look to another user. FIG. 11 is a diagram of a web browser 30, as it would be viewed by a user of a network client. FIG. 11 shows a typical Web browser 30, which includes a browser window 32 for viewing web pages, as well as menus, buttons, an address line, and other items typically found in a standard Web browser. FIG. 11 also shows a toolbar 34, which illustrates one example of how the present invention can be implemented. In this example, the toolbar 34 is a result of software installed on the network client, which controls the various functions of the present invention. The toolbar 34 includes various menus and buttons which can be configured to perform any desired functions. The invention may be implemented in any desired manner, including a toolbar, a browser plug-in, and browser extension, local executable, active X control, etc.

Within the browser window 32 the contents of the current web page can be viewed. In the example shown in FIGS. 11-17, a typical profile web page from a social network is shown. FIG. 11 illustrates various contents of the profile web page, which can include text, graphics, media, etc. FIG. 11 shows various examples of generic content including text, images (the blocks with shading), and other generic content. Note that in this example, the web page shown in FIG. 11 in the browser window 32 is a web page retrieved from a web server, and is unaltered.

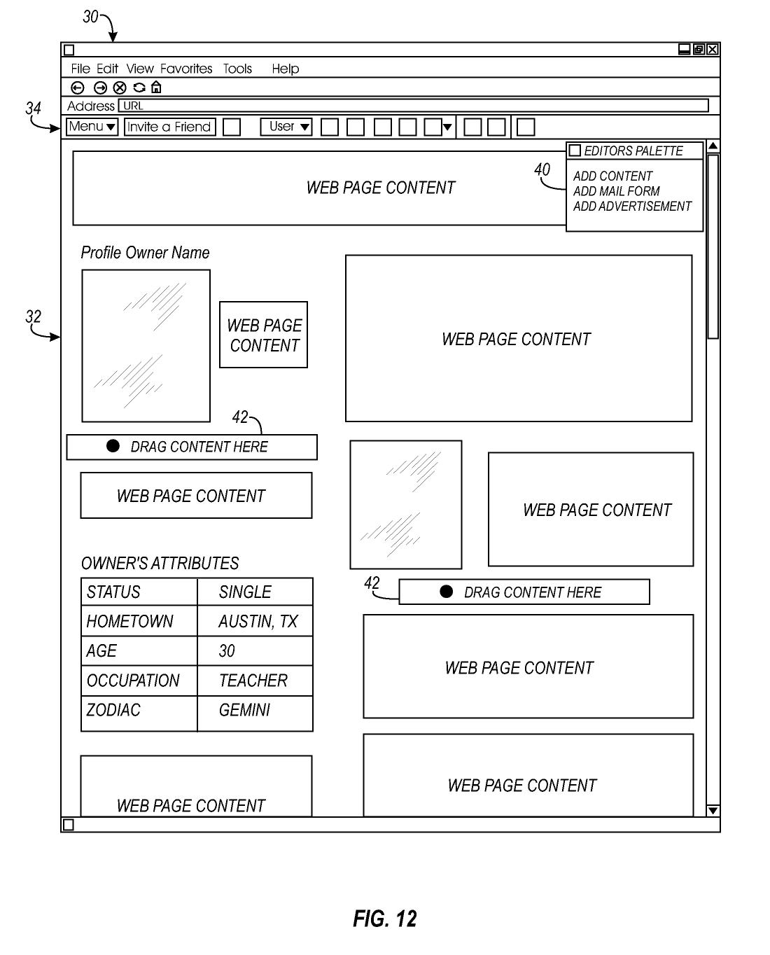

When the profile owner desires to add owner generated content, the profile owner can click one of the buttons on the toolbar (or invention palette in the page) 34 to place the current profile page into edit mode. FIG. 12 is a diagram of the Web browser 30, with the toolbar 34 placed in the edit mode. The toolbar 34 generates a menu 40 (labeled “Editors Palette”) which provides the profile owner with various options for adding content to the underlying profile page. In the example shown in FIG. 12, the profile owner can select either “add content,” “add mail form,” or “add advertisement”. Of course, any other desired options can be included in the menu 42. FIG. 12 also shows the addition of content anchor points 42 labeled “Drag Content Here” (described in more detail below). In this example, the two anchor points 42 shown are located in predetermined locations, based on site-specific scripts. In one example, site-specific scripts are provided by the application server (i.e., server side scripts) and are based on the host or domain of the web page being viewed. A site-specific script may be based on any desired component of a web page URL (e.g., host, domain name, sub domain, query string, etc.). An anchor point list may also be provided by an xpath provided in the site-specific script. Alternatively, the content locations could be chosen by the profile owner. The predetermined anchor points 42 in this example are located in certain areas that can be predetermined since the general web page layout of web pages in any particular social network host are known in advance.

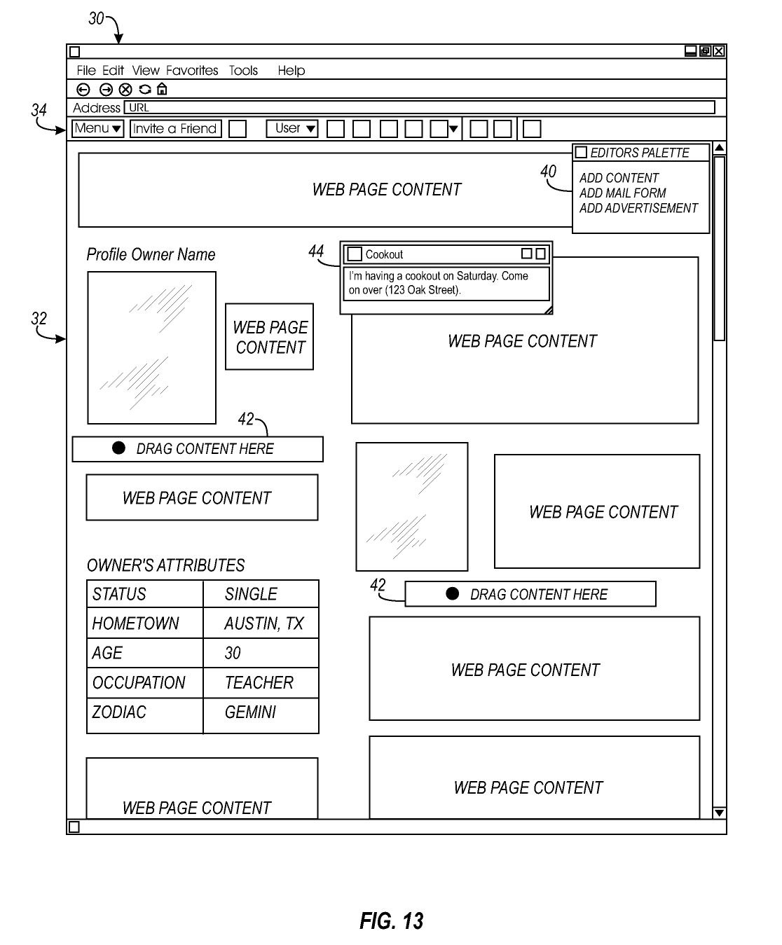

FIG. 13 is a diagram of the Web browser 30, illustrating the profile owner adding content. In this example, the profile owner selected “add content” in the menu 40. This action generates a content box 44 (WYSIWYG html editor), which the content owner can use to add any desired content. In this example, the content box includes a title bar, a workspace, and various buttons. In one example, the buttons can be used to allow user to delete the box 44, edit the contents of the box 44, etc. in the example shown in FIG. 13, the content box 44 includes a title, and simple text. Content added by a profile owner can include various other types of content such as graphics, links, multimedia, advertisements, etc. the present invention can also provide the profile owner with various tools to help generate the content. Examples of such tools include, but are not limited to, a text editor, tools for inserting hyperlinks, tools for inserting graphics and multimedia, etc. The content box 44 also includes menus for allowing the profile owner to configure content visibility authentication options, such as passwords.

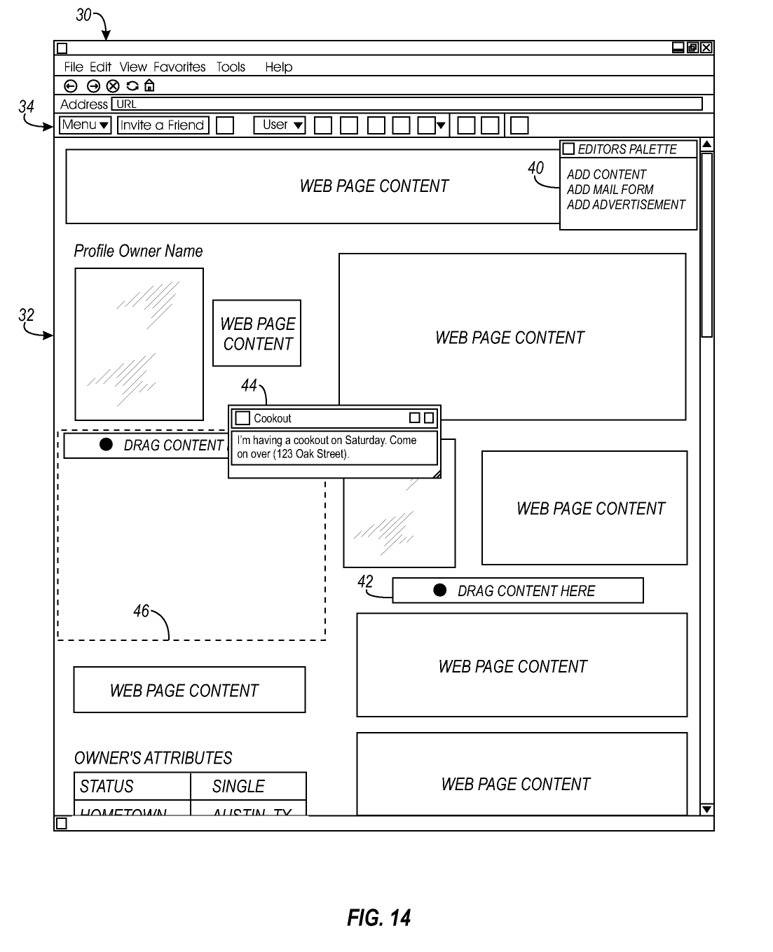

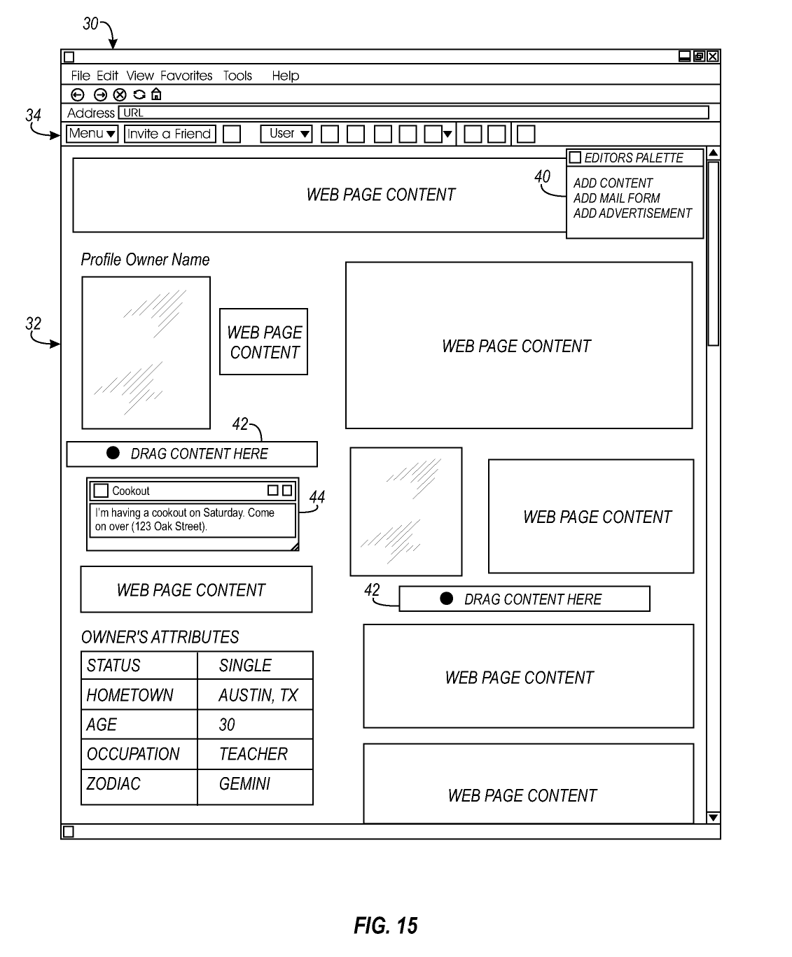

The profile owner has various options relating to where the generated content is located. For example, the profile owner can configure the content to be a floating box such as the content box 44 as shown in FIG. 13. In one example, another user that can view the content box 44 when navigating to the profile owners web page is allowed to temporarily move the floating box where desired, although the content owner chooses the initial originating position of the content box 44 as seen by other users. Alternatively, the profile owner can choose to anchor the content at one of the anchor points 42. FIG. 14 is a diagram of the Web browser 30, as the profile owner drags the content box 44 toward one of the anchor points 42. As shown, when the content box 44 becomes close enough to the anchor point 42, an anchor box 46 appears (the dashed line). The content and box 44 can be placed within the anchor box 46, which will cause the content box 44 to be anchored in place on the web page. Note that the original web page content is still there, but the page is adjusted to fit everything this user is authorized to see. FIG. 15 is a diagram of the Web browser 30, after is the content box 44 has been anchored in place. As shown, the content is displayed inline with other content of the web page. Note that the invention also includes provisions to prevent the placement of user added content over such elements on the underlying web page as advertisements, security notices or other assets that are displayed on the originating web site. Additionally, the invention permits the viewers of added content to “tag it” (label it with meaningful search terms) for assistance locating it in the future, and also to help to prevent hate, porn, copyright infringement, etc.

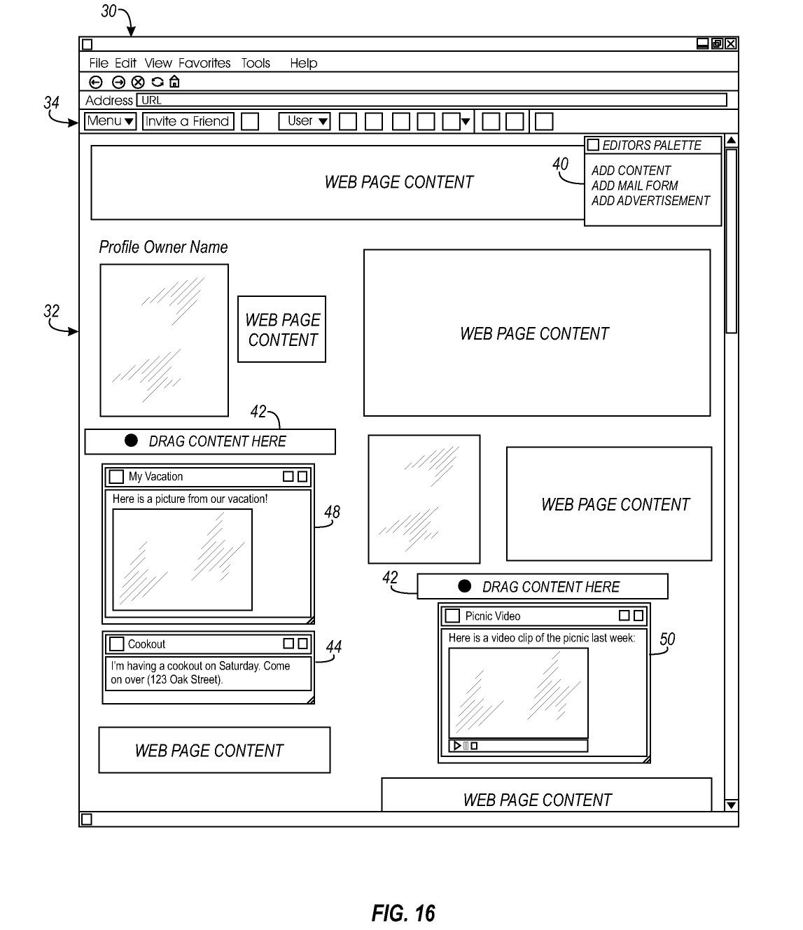

FIG. 16 is a diagram of the Web browser 30, illustrating the addition of more content. In addition to the content box 44, a second content box 48 has been added to the same anchor point 42. In this example, the content box 48 includes text and graphics. A third content box 50 has been added to the other anchor point 42. In this example, the content box 50 includes text and a multimedia clip.

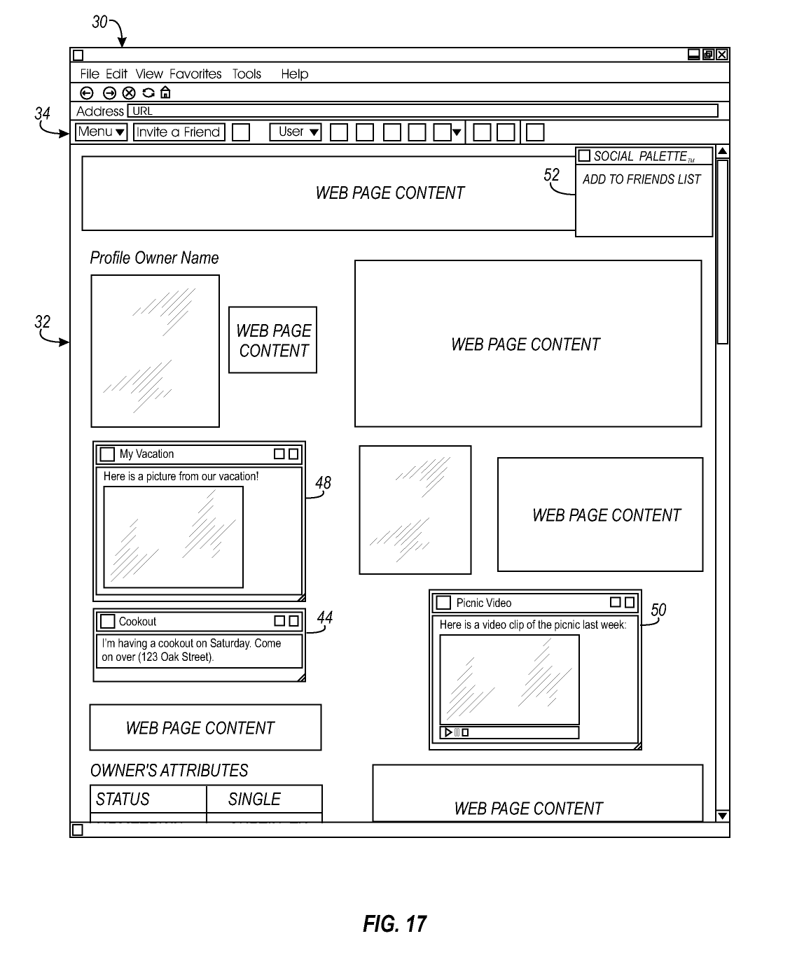

When the profile owner is finished adding new content or editing existing content blocks, the invention will “publish” all changes back to the application server and database. FIG. 17 is a diagram of the Web browser 30, illustrating the added content, after the profile owner published. FIG. 17 also illustrates what the customized web page will look like to another user that uses the toolbar 34, and is authorized to see the added content. In this example (what another user would see), a menu 52 (labeled with the mark “Social Palette™”) is also shown. The menu 52 may include various menu items. For example, the menu 52 can allow a user to add the currently viewed user profile to their friends list (described below). Note again that all of the original web page content is still displayed, even after the user added content is injected into the web page.

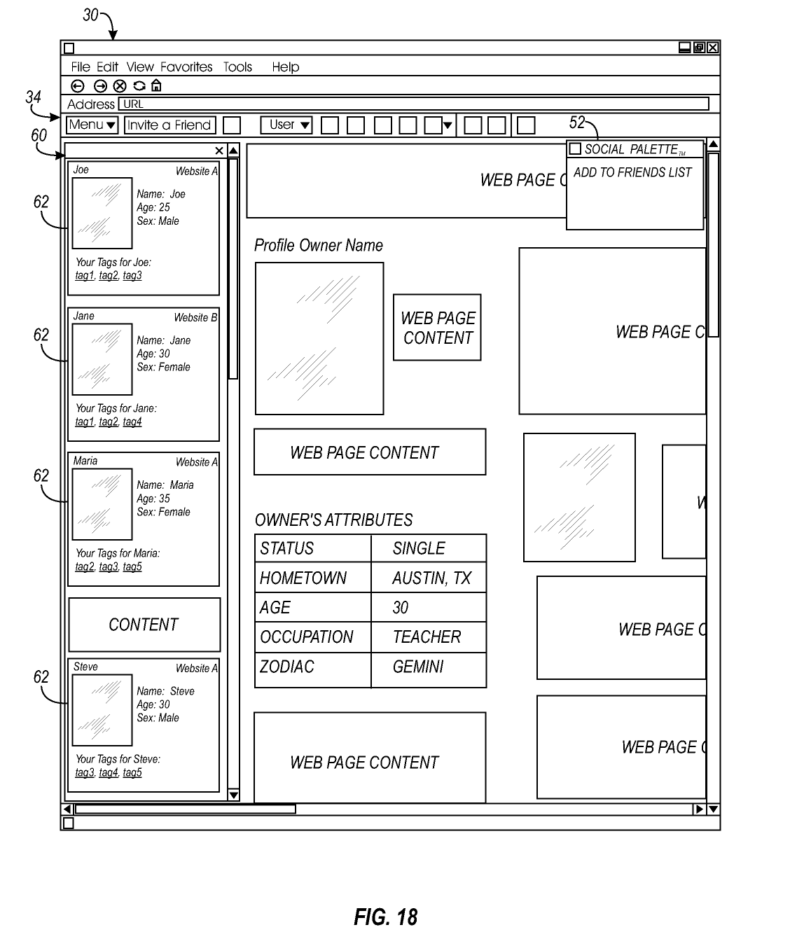

The present invention includes various features that will enhance a user's social networking experience. One feature relates to the management of contacts and friends. The present invention allows a user to maintain a contact/friend list to track friends and profiles from multiple social network and other web sites. FIG. 18 is a diagram of the Web browser 30, illustrating a multi-site contact list sidebar 60. In this example, the sidebar shows four saved contacts/friends 62 that have been saved by a user. Each saved contact includes various information including a picture, profile information, tags, and the web site from which the contact was saved. FIG. 18 also illustrates that the contact sidebar can include other content, such as advertisements. Below each friend/contact can be an “email me” link that allows some friends to be emailed without using the mail service of the underlying social network.

In one example, the invention allows a user to click a button on the toolbar, or on the social menu 52, while viewing a friend's profile on a social networking or other web site. This profile is captured, tags can be added, and then the entry can be saved by the palette, along with other profiles previously selected by the user. In this way, the user can collect, organize and manage contacts/profiles in a friends list spanning multiple social networks. For example, a user may go to a first social network and select Joe's profile, then go to a second social network and select Jane's profile, etc. This contact list may be saved and viewed in any desired manner. In one example, the toolbar provides a sidebar which, when not hidden, lists the selected profiles from the various social networks. In the example above, Joe and Jane are be listed in the same place (e.g., in the side bar list), despite the fact that they belong to different social networks. Clicking on either entry would take you to the specific user profile on the original site from which it was added.

The friends/contacts list can be displayed in any desired manner. The list may include pictures, names, nicknames, usernames, marital status, contact information etc. If desired, a user can control what portions of a user's profile are shown in the contact list. A user may also search, categorize and/or sort contacts by category, keywords, tags, etc. In addition, the present invention allows a user to import or export friends and contacts from social networking sites, other applications or lists. When the user clicks on a contact in the contact list, the browser will be directed to that user's profile, on whatever social network the person belongs to. This way, a user of the present invention can easily view the profiles and web pages of their friends, by simply clicking on their profile in the contact list. Another advantage of this feature, is that a person having multiple profiles can be associated with a single entry in the friends list. For example, in the example provided above, Joe may have a profile of both the first and second social networks. The toolbar of the present invention allows the user to store, track and manage Joe's multiple profiles from one central place.

In one example, advertisements can be included in the sidebar (or wherever the contact list is displayed). When a user is browsing their contact list, they may view ads placed among the contact list. For example, the block labeled “Content” in FIG. 18 may be an advertisement served by the toolbar. End users can even place advertisements in their added content, and then be compensated based on how many of their friends/other social networkers visit their page and view the ads.

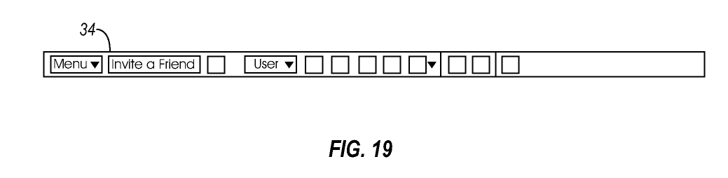

As mentioned above, the present invention may be implemented in any desired manner. FIGS. 11-18 show an example where the invention uses a web browser toolbar 34 as an interface between the web browser and the user. FIG. 19 is a diagram illustrating the toolbar 34 shown in FIGS. 11-18. The toolbar includes various pull down menus and buttons to allow the user to configure the various features of toolbar, as well as use the toolbar. Examples of functions that may be associate with buttons on the toolbar 19 include an invitation function (to invite friends to use the toolbar), a profile selection menu (to select one of a plurality of user profiles), shortcuts to specific pages on social networking pages (e.g., profile page, email page, account page, friends page, inbox, etc.), jumping to your editable profile pages, toggling of content viewing (i.e., allows the user to either view or not view additional content generated by the profile owner), etc. The buttons on the toolbar can be associated with site-specific scripts, such that the buttons are automatically configured for whatever web site is being viewed, or for whatever user (account) has been selected in the pull down menu.

The toolbar 34 may also include indicators to convey information to a user. For example, an indicator can provide an indication that the web browser is viewing a supported web site. In another example, an indicator can let a user know that the profile owner is also a toolbar user or that owner generated content is available on the currently viewed page.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of displaying content at an internet client comprising:
providing a database containing information on a plurality of profile owners, wherein for each of the plurality of profile owners, the database stores content generated by the respective profile owner, and wherein the content is intended to be displayable in conjunction with one or more web pages;
receiving a request from a first user of an internet client to view a first web page containing information relating to a profile of a first profile owner;
determining whether at least a portion of the requested first web page corresponds to content stored in the database; and
displaying at the internet client of the first user the first web page with content added from the database, wherein the content added from the database is content generated by the first profile owner.

2. The method of claim 1, wherein the database resides in conjunction with an application server.

3. The method of claim 1, further comprising determining whether the first user is authorized to view content generated by the first profile owner that is stored in the database.

4. The method of claim 3, wherein the added content is displayed with the first web page only if it is determined that the first user is authorized to view the content from the database generated by the first profile owner.

5. The method of claim 1, wherein the added content is displayed with the first web page only if the first user has entered an authorized password.

6. The method of claim 1, wherein the added content is displayed with the first web page only if the first user is listed in a contact list maintained by the first profile owner.

7. The method of claim 1, wherein the added content is displayed with the first web page only if the first user possesses attributes specified by the first profile owner.

8. The method of claim 1, wherein the content added to the first web page is displayed in a floating window.

9. The method of claim 8, wherein the starting location of the floating window is chosen by the first profile owner.

10. The method of claim 1, wherein the content added to the first web page is anchored to the first web page at a predetermined anchor point.

11. The method of claim 10, wherein the content is displayed inline with other content of the first web page.

12. The method of claim 10, wherein the anchor point is one of a plurality of possible predetermined anchor points.

13. The method of claim 12, wherein the plurality of possible predetermined anchor points is specified by a server side script supplied by the application server, wherein the server side script is based on some component of the first web page URL.

14. The method of claim 1, wherein the content added to the first web page is anchored to one of a plurality of predetermined anchor points.

15. The method of claim 14, wherein the anchor point to which the added content is anchored is chosen by the first profile owner.

16. A method of displaying content on an internet client comprising:
receiving a request from a first user of an internet client to view a first web page containing information relating to content generated by a second user;
receiving content at the internet client from a first web server, the content corresponding to the first web page;
receiving content at the internet client from an application server, the content from the application server relating to content generated by the second user; and
displaying on an internet browser at the internet client a customized web page containing content from the first web server and the content from the application server.

17. The method of claim 16, further comprising determining from the content received from the first web server whether any content exists on the application server relating to content generated by the second user.

18. The method of claim 16, further comprising determining whether the first user is authorized to view the content from the application server.

19. The method of claim 18, wherein the customized page is displayed only if it is determined that the first user is authorized to view the content from the application server.

20. The method of claim 16, wherein the customized page is displayed only if the first user has entered an authorized password.

21. The method of claim 16, wherein the customized page is displayed only if the first user is listed in a contact list maintained by the second user.

22. The method of claim 16, wherein the customized page is displayed only if the first user possesses attributes specified by the second user.

23. The method of claim 16, further comprising using software installed on the internet client to facilitate receiving of content from the application server and displaying the customized page.

24. The method of claim 23, wherein the software is a web browser toolbar.

25. The method of claim 23, wherein a second internet client that does not include the software can not display the customized page containing content from the first web server and the content from the application server.

26. The method of claim 23, wherein the customized page containing content from the first web server and the content from the application server is only viewable by an internet client containing the software.

27. The method of claim 16, wherein the internet client is configured to add content to other web pages containing content from other web servers and content from one or more application servers.
